(19) United States
(12) Patent Application Publication
(10) Pub. No.: US 2005/0135761 A1
(43) Pub. Date: Jun. 23, 2005

(54) Optical element for uniform illumination and optical system incorporating same

(76) Inventors: Bruce L. Cannon, Portland, OR (US); Peter R. Oehler, Aloha, OR (US)

Correspondence Address: 3M INNOVATIVE PROPERTIES COMPANY, PO BOX 33427, ST. PAUL, MN, 55133-3427, US

(21) Appl. No.: 10/744,994

(22) Filed: Dec. 23, 2003

(51) Int. Cl. G02B 6/20; G02B 6/02; G02B 6/10

(52) U.S. Cl. 385/125; 385/146; 385/901

(57) ABSTRACT

An optical element for homogenizing light and an optical system incorporating same are disclosed. The optical element includes an optical rod that has an input face and an output face. The input face of the optical element is not parallel to the output face of the optical element.

### FIELD OF THE INVENTION

This invention generally relates to illumination devices. The invention is particularly applicable to illumination devices producing uniform illumination.

### BACKGROUND

Projection systems typically include a light source, an active light valve for producing an image, an illumination system for illuminating the light valve, and optics for projecting and displaying the image.

It is often desirable to illuminate the light valve uniformly and with good optical efficiency so as to increase brightness, resolution and contrast of a displayed image.

### SUMMARY OF THE INVENTION

Generally, the present invention relates to illumination systems.

In one embodiment of the invention, an optical element for homogenizing light includes an optical rod having an input face and an output face, where the input face is not parallel to the output face.

In another embodiment of the invention, an optical element includes an input face for receiving light from a light source. The optical element further includes a body for homogenizing and transmitting the light received by the input face. The optical element further includes an output face for delivering the homogenized light. The input face cannot be made to overlay the output face by one or more translational shifts of the input face.

In another embodiment of the invention, an optical system includes a light source. The optical system further includes an optical element that receives light from the light source from an input face of the element. The optical element homogenizes the received light and transmits the homogenized light from an output face of the optical element. The input face of the optical element is not parallel to the output face of the optical element. The optical system further includes a light valve having an active area. The active area is disposed to receive the light transmitted from the output face of the optical element. The optical system further includes relay optics for delivering the transmitted light to the active area of the light valve. The relay optics images the output face of the optical element onto the active area of the light valve.

In another embodiment of the invention, an optical system includes an optical element that is centered on an optical axis. The optical element homogenizes light. The optical element has an input face and an output face. The optical system further includes an active area of a light valve. The active area makes a non-zero angle with a normal to the optical axis. The optical system further includes relay optics that images the output face of the optical element onto the active area of the light valve. The active area lies in an image plane of the output face imaged by a relay optics.

### BRIEF DESCRIPTION OF DRAWINGS

The invention may be more completely understood and appreciated in consideration of the following detailed description of various embodiments of the invention in connection with the accompanying drawings, in which:

FIG. 1 illustrates a schematic side-view of an optical system in accordance with one embodiment of the invention;

FIG. 2 illustrates a schematic three-dimensional view of an optical element in accordance with another embodiment of the invention;

FIG. 3 illustrates a schematic three-dimensional view of an optical element in accordance with another embodiment of the invention;

FIG. 4 illustrates a schematic three-dimensional view of an optical element in accordance with another embodiment of the invention; and

FIG. 5 illustrates selected points of illumination intensity of different illumination systems.

### DETAILED DESCRIPTION

The present invention generally relates to projection displays. The invention is particularly applicable to projection displays with reflective imagers, and even more particularly to projection displays having a digital micromirror imager (DMD).

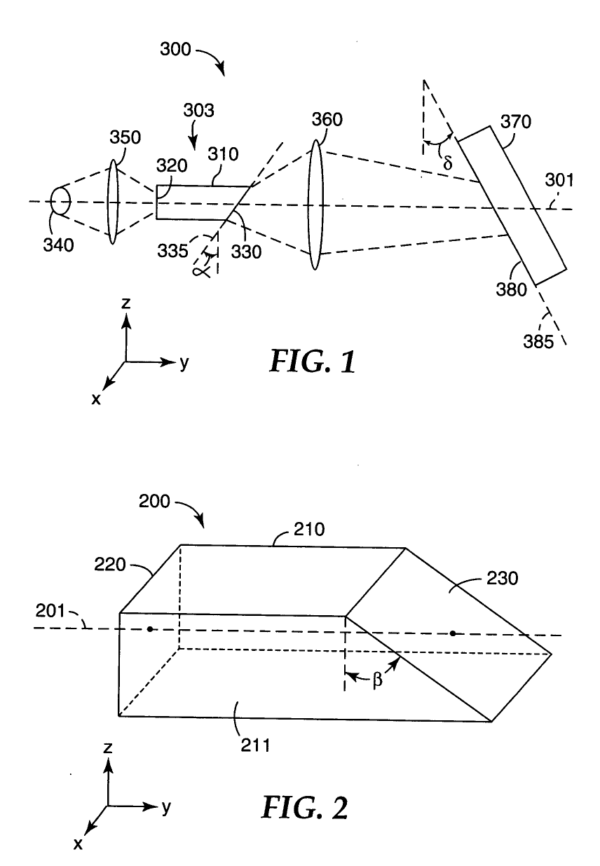

FIG. 1 illustrates a schematic side-view of an optical system 300 in accordance with one embodiment of the invention. Optical system 300 is an optical illumination system providing uniform and efficient illumination to an image source. Optical system 300 includes a light source 340, a light focusing element 350, a light homogenizing optical element 303, relay optics 360, and a light valve 370 having an active area 380.

Optical element 303 is a light homogenizing element, homogenizing light received from source 340, where by homogenizing it is meant that light exiting optical element 303 has a more uniform intensity distribution than light entering optical element 303. Optical element 303 is centered on an optical axis 301 and includes an input face 320, an output face 330, and an optical rod 310. Examples of known light homogenizers may be found in U.S. Pat. Nos. 5,625,738 and 6,332,688; and U.S. Patent Application Publication Nos. 2002/0114167, 2002/0114573, and 2002/0118946. According to one embodiment of the invention, input face 320 is not parallel to output face 330, meaning that the plane of input face 320 intersects the plane of output face 330. In other words, the magnitude of the angle between the plane of input face 320 and the plane of output face 330 is greater than zero. Input face 320 is normal to optical axis 301, that is, the plane of input face 320 makes a 90° angle with optical axis 301. Output face 330 makes an angle α with a plane normal to optical axis 301, that is, the plane of output face 330 makes an angle α with a plane normal to optical axis 301. Active area 380 of light valve 370 makes an angle δ with a plane normal to the optical axis, where the magnitude of angle δ is greater than zero. Angle δ may or may not be equal to angle α.

Light focusing element 350 collects light from light source 340 and transmits the collected light to input face 320 of optical element 303. Optical element 303 receives light from the light source from its input face 320. Optical rod 310 homogenizes the received light and transmits the homogenized light from output face 330. Relay optics 360 delivers the light homogenized and transmitted by optical element 303 to an active area 380 of light valve 370. According to one embodiment of the invention, relay optics 360 images output face 330 of optical element 303 onto active area 380 of light valve 370. Furthermore, output face 330 defines an object plane 335, and active area 380 defines an image plane 385. According to one embodiment of the invention, image plane 385 is an image of object plane 335 imaged by relay optics 360.

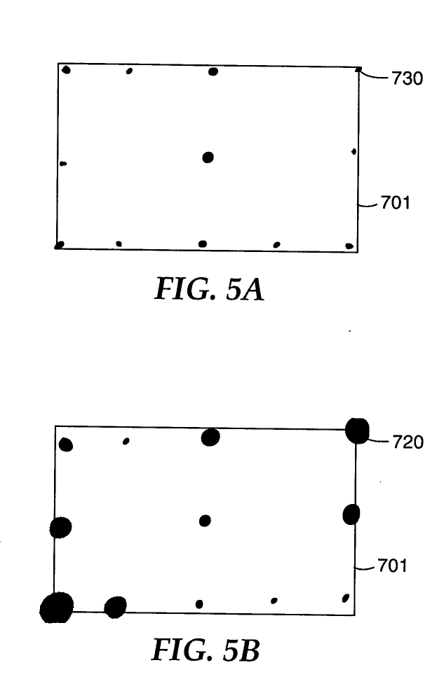

The results of tracing rays from output face 330 to selected points on active area 380 are shown in FIG. 5A, where the following exemplary assumptions and values were used: Optical element 303 was a solid rod having a rectangular cross-section. The output face 320 was a rectangle 8 mm wide and 4.5 mm high. The active area 380 was a rectangle 17.51 mm wide and 9.85 mm high. Relay optics 360 was a lens system with an effective focal length of 51.37 mm and a magnification factor of 2.31. Furthermore, α was 6.8 degrees and δ was 26 degrees. Area 701 in FIG. 5 corresponds to active area 380 of light valve 370. The smallness of individual points in FIG. 5A indicate that active area 380 lies in the image plane of output face 330 imaged by relay optics 360. The smallness of the points in FIG. 5A further indicates uniform and efficient illumination of active area 380.

For comparison, FIG. 5B shows the results of a similar ray tracing for an illumination system where the optical element 303 was replaced with a known rectangular prism light homogenizer, such as one discussed in U.S. Pat. No. 5,625,738. The relatively large points in FIG. 5B indicate that the active area of the light valve is not in the image plane of the output face of the known rectangular prism light homogenizer imaged by relay optics 360. In contrast, a comparison of corresponding spots in FIGS. 5A and 5B (such as spots 730 and 720) indicates that, for the light homogenizing element of the present invention, output face 330 and active area 380 form an object-image relationship, meaning that, active area 380 lies in an image plane of output face 330, as imaged by relay optics 360. Small spot-size image points in FIG. 5A indicate uniform illumination. As such, an advantage of the present invention is uniform illumination. Uniform illumination is achieved by using a light homogenizing optical element having an output face which is imaged by relay optics onto an active area of a light valve, where the active area makes a non-zero angle with a normal to the optical axis, that is, the active area is not normal to the optical axis.

In general, output face 330 may have a shape that is different than the shape of active area 380. For example, output face 330 may be a trapezoid and active area 380 may be a square. In some applications, output face 330 and active area 380 may have the same shape, such as a rectangle or a square.

Light valve 370 may be a liquid crystal display (LCD), a switchable mirror display, such as a digital micromirror device (DMD) from Texas Instruments, a micro-electromechanical system (MEMS), such as a grating light valve (GLV) discussed, for example, in U.S. Pat. No. 5,841,579. In general, light valve 370 can be any switchable device capable of forming an image.

Optical system 300 may be telecentric, meaning that one or both of an entrance pupil and an exit pupil of optical system 300 can be located at or near infinity.

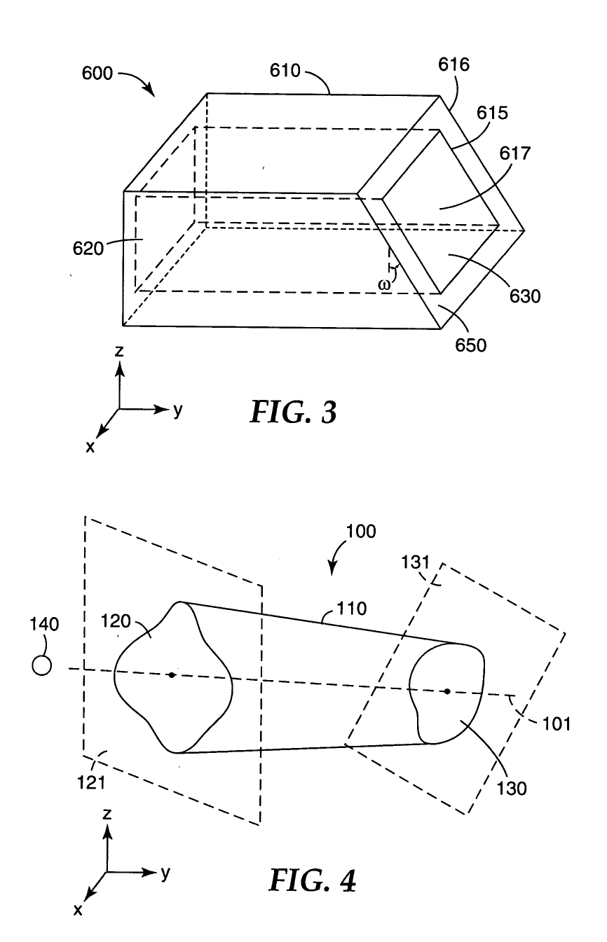

Optical system 300 may further include other elements not shown in FIG. 3. For example, optical system 300 may include apertures, prisms, mirrors, or any other elements or components that may be suitable for use in an illumination system.

The layout in FIG. 3 shows an unfolded optical system, meaning that optical axis 301 is a straight line, not folded at any point along the optical axis. To economize space, optical system 300 may be folded at one or more points along optical axis 301.

FIG. 2 illustrates a three-dimensional schematic of an optical element 200 as one particular embodiment of optical element 303 of FIG. 1. Optical element 200 homogenizes light that enters the optical element through an input face 220 of optical element 200. Optical element 200 further includes an optical rod 210 and an output face 230. Light entering optical element 200 is homogenized, for example, as it travels along the optical rod by, for example, reflection or total internal reflection off of the sides 211 of the optical rod. Sides 211 can form an interface between the optical rod and what surrounds the optical rod, such as air. Sides 211 can be planar. Sides 211 can be curved, for example, to focus the light as it propagates along the optical rod. As an example, and without loss of generality, optical element 200 is centered on an optical axis 201 that extends along the y-axis. The index of refraction of a solid optical rod 210 may vary along optical axis 201. For example, optical rod 210 may have a gradient index along optical axis 201 to, for example, bend or focus the light as it propagates along the optical rod. Input face 220 is a rectangle and is normal to the optical axis 201. Output face 230 is also a rectangle and makes an angle β with the xz-plane where the magnitude of angle β is greater than zero. Optical rod 210 has a rectangular cross-section

According to one embodiment of the invention, input face 220 is not parallel to the output face 230. In this particular embodiment of the invention, an input plane defined by input face 220 intersects and makes the angle β with an output plane defined by output face 230. It will be appreciated that no one or multiple translational shifts of input face 220 can result in input face 220 overlay or coincide output face 230.

It will further be appreciated that input face 220, output face 230, and a cross-section of optical rod 210 can have a shape other than rectangle, such as a trapezoid, a square, or any other shape that may be desirable in an application. Furthermore, input face 220, output face 230 and a cross-section of optical rod 210 can have different shapes. For example, input face 220 can be a rectangle, while output face 230 and a cross-section of optical rod 210 can be squares. A cross-section of optical rod 210 can be different at different locations along the optical rod. For example, optical rod 210 may be tapered along its major length along optical axis 201. The sides of a cross-section of optical rod 210 may be straight or curved. An example of a tapered optical rod is described in U.S. Pat. No. 6,332,688.

A portion of or the entire optical element 200 can be solid or hollow. An example of a hollow light homogenizer is illustrated in reference to FIG. 3.

FIG. 3 illustrates a three-dimensional schematic of a light homogenizing optical element 600 in accordance with one embodiment of the invention. Optical element 600 can function as optical element 303 in FIG. 1. Optical element 600 includes an input face 620, an output face 630, and an optical rod 610. Output face 630 is not parallel to input face 620. In particular, output face 630 makes an angle ω with input face 620, where the magnitude of angle ω is greater than zero. Optical rod 610 includes a core 617, and a cladding 650. Cladding 650 includes an interior surface 615 and an exterior surface 616.

Core 617 may be air in which case optical element 600 is hollow. In such a case, interior surface 615 may be highly reflective, for example, by including a reflective layer, such as a metal coating, a metal coating with a multilayer enhancement coating, or a multilayer dielectric coating. The multilayer dielectric coating can include organic layers, such as a multilayer optical film (MOF) discussed in, for example, U.S. Pat. No. 5,882,774. The MOF can function as a filter and a reflector by, for example, reflecting light in the visible region of the spectrum and transmitting light in the infrared region of the spectrum. Examples of metals that can be used in a metal coating include silver, aluminum, and gold. Light can be homogenized by multiple reflections from a highly reflective interior surface 616. The entire cladding 650 may be made of a metal.

Core 617 may include a solid material. The solid material may be made of glass or organic material. Exemplary glass materials include soda lime glass, borosilicate glass, borate glass, silicate glass, oxide glass and silica glass, or any other glass material that may be suitable for use as a core material. Exemplary organic materials include polycarbonate, acrylic, polyethylene terephthalate (PET), polyvinyl chloride (PVC), polysulfone, and the like. Where core 617 includes a solid material, cladding 650 preferably has an index of refraction that is lower than the index of refraction of the core material to facilitate reflection including total internal reflection of light propagating along the optical rod.

Core 617 may include a fluid. Exemplary fluids include ethylene glycol, mixtures of ethylene glycol and glycerol, mixtures of ethylene glycol and water, liquids including a siloxane polymer having methyl, phenyl, and hydrophilic side groups, and liquids including mixtures of a siloxane polymer having methyl and phenyl side groups and a siloxane polymer having methyl and hydrophilic side groups. A fluid core material can assist in heat sinking light source 340 or focusing element 350.

Core 617 can scatter light. For example, core 617 may include particles dispersed in a host material where the index of refraction of the particles is different than that of the host material, in which case, particles can scatter light, thereby assist in homogenizing light.

FIG. 4 illustrates a schematic side view of an optical element 100 in accordance with one embodiment of the invention. Optical element 100 homogenizes light received from a light source 140. Optical element 100 is centered on an optical axis 101. Optical axis 101 can be straight, as shown in FIG. 4, curved, or a combination of one or more straight and curved line segments. In general, optical axis 101 can have any shape that may be desirable in an application. Optical element 100 includes an input face 120, a body 110, and an output face 130. Optical element 100 receives light from light source 140 through input face 120. Light entering body 110 becomes more uniform, for example, as it travels along the body. Body 110 can be a rod, where at least a portion of the rod may be solid or hollow. Homogenized light exits body 110 through output face 130. By homogenization, it is meant that light exiting optical element 100 is more uniform than light entering the optical element.

According to one embodiment of the invention, input face 120 is not parallel to output face 130. For example, input face 120 cannot be made to overlay or coincide output face 130 by one or more translational shifts of input face 120 along, for example, x, y, or z-axes, or a combination thereof. Translational shifts of input face 120 combined with one or more rotations or tilts of input face 120 may cause the input face to overlay the output face. One or both of input face 120 and output face 130 may be planar or non-planar. One or more of input face 120, output face 130, and a cross-section of body 110 may have any shape having a regular or irregular perimeter. For example, the perimeter of one or more of input face 120, output face 130, and a cross-section of body 110 may be a circle, an ellipse, a polygon, such as a quadrilateral, a rhombus, a parallelogram, a trapezoid, a rectangle, a square, or a triangle.

Input face 120 can define an input plane 121 and output face 130 can define an output plane 131. According to one embodiment of the invention, input plane 121 and output plane 131 are not parallel, meaning that planes 121 and 131 intersect, for example, when one or both are sufficiently extended. According to one embodiment of the invention, input plane 121 cannot be made to overlay or coincide output plane 131 by one or more translational shifts of the input plane 121, where by a translational shift of input plane 121, it is meant a shift of input plane 121 that can be expressed as a combination of shifts along the x, y, and z-axes Input face 120 can be normal to optical axis 101.

Optical element 100 can have any three-dimensional shape, for example, a polyhedron, such as a hexahedron. Optical element 100 can be solid or hollow. Optical element 100 may homogenize an input light by any suitable optical method such as reflection, total internal reflection, refraction, scattering, or diffraction, or any combination thereof.

Optical transmittance of optical element 100 is preferably no less than 50%, more preferably no less than 70%, and even more preferably no less than 80%, where optical transmittance is the ratio of total light intensity exiting output surface 130 to total light intensity incident on input face 120.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

1. An optical element for homogenizing light, the element comprising an optical rod having a light input face and a light output face, the input face not being parallel to the output face.

2. An illumination system comprising the optical element of claim 1.

3. The optical element of claim 1, wherein at least a portion of the optical element is hollow.

4. The optical element of claim 1, wherein at least a portion of the optical element is solid.

5. The optical element of claim 1, wherein the optical rod is tapered.

6. The optical element of claim 1, wherein the optical element is centered on an optical axis that is normal to the input face.

7. The optical element of claim 1, wherein the input face is a rectangle.

8. The optical element of claim 1, wherein the output face is a rectangle.

9. The optical element of claim 1, wherein the input face is a square.

10. The optical element of claim 1, wherein the output face is a square.

11. The optical element of claim 1, wherein the output face is a trapezoid.

12. An optical element comprising:
an input face for receiving light from a light source;
a body for homogenizing and transmitting the light received by the input face; and
an output face for delivering the homogenized light, wherein the input face cannot be made to overlay the output face by one or more translational shifts of the input face.

13. The optical element of claim 12, wherein the optical element is centered on an optical axis that is normal to the input face.

14. The optical element of claim 12, wherein the body is a rod.

15. The optical element of claim 14, wherein at least a portion of the rod is solid.

16. The optical element of claim 14, wherein at least a portion of the rod is hollow.

17. The optical element of claim 12, wherein the body comprises a fluid.

18. An optical system comprising:
a light source;
an optical element receiving light from the light source from an input face of the element, the optical element homogenizing the received light and transmitting the homogenized light from an output face of the optical element, the input face not being parallel to the output face; and
a light valve having an active area disposed to receive the light transmitted from the output face of the optical element; and
a relay optics for delivering the light transmitted from the output face of the optical element to the active area of the light valve, the relay optics imaging the output face of the optical element onto the active area of the light valve.

19. The optical system of claim 18, wherein the light valve is a liquid crystal display.

20. The optical system of claim 18, wherein the light valve is a digital micromirror device.

21. The optical system of claim 18, wherein the light valve is a grating light valve.

22. The optical system of claim 18, wherein the optical system is centered on an optical axis.

23. The optical system of claim 22, wherein the light valve is not normal to the optical axis.

24. The optical system of claim 22, wherein the input face of the optical element is normal to the optical axis.

25. The optical system of claim 22, wherein the output face of the optical element is not normal to the optical axis.

26. A projection system comprising the optical system of claim 18.

27. The optical system of claim 18 being telecentric.

28. An optical system comprising:
an optical element centered on an optical axis for homogenizing light and having an input face and an output face;
an active area of a light valve making a non-zero angle with a normal to the optical axis; and
a relay optics imaging the output face of the optical element onto the active area of the light valve.

29. The optical system of claim 28, wherein the input face of the optical element is normal to the optical axis.

30. The optical system of claim 28, wherein the output face of the optical element is not normal to the optical axis.

31. The optical system of claim 28, wherein the input face of the optical element is not parallel to the output face of the optical element.

32. The optical system of claim 28, wherein the light valve is a liquid crystal display.

33. The optical system of claim 28, wherein the light valve is a digital micromirror device.

34. The optical system of claim 28 being telecentric.
